(19) United States
(12) Patent Application Publication
(10) Pub. No.: US 2014/0364520 A1
(43) Pub. Date: Dec. 11, 2014

(54) COMPOSITION FOR PAINTING AND VARNISHING PARTS OF VEHICLE AND VARNISHING PARTS OF VEHICLE USING THE SAME

(71) Applicants: HYUNDAI MOBIS CO., LTD., Seoul (KR); SAMHWA PAINTS INDUSTRIAL CO., LTD., Ansan-si (KR)

(72) Inventors: Woo Jeong Oh, Yongin-si (KR); Woo Jin Ha, Yongin-si (KR); Hyeon Don Kim, Yongin-si (KR); Yong Chun, Yongin-si (KR); Se Yoon Pang, Seoul (KR)

(73) Assignees: HYUNDAI MOBIS CO., LTD., Seoul (KR); SAMHWA PAINTS INDUSTRIAL CO., LTD., Ansan-si (KR)

(21) Appl. No.: 14/290,635

(22) Filed: May 29, 2014

(30) Foreign Application Priority Data
Jun. 11, 2013 (KR) 10-2013-0066807

(51) Int. Cl. C09D 133/08

(52) U.S. Cl. CPC C09D 133/08
USPC 521/56

(57) ABSTRACT

The present invention relates to a composition for painting and varnishing parts of a vehicle, including: 20 to 50 wt % of thermosetting resin; 1 to 10 wt % of thermal expandable microsphere; 3 to 20 wt % of pigment; 5 to 20 wt % of hardener; 1 to 20 wt % of additives; a residual solvent; and 5 to 20 wt % of hardener added later and parts of a vehicle including a paint film made of the composition.

### CROSS-REFERENCES TO RELATED APPLICATIONS

The present application claims priority under 35 U.S.C. 119(a) to Korean Application No. 10-2013-0066807, filed on Jun. 11, 2013, in the Korean Intellectual Property Office, which is incorporated herein by reference in its entirety set forth in full.

### BACKGROUND

Exemplary embodiments of the present invention relate to a composition for painting and varnishing parts of a vehicle and varnishing parts of a vehicle using the same.

At present, a texture forming paint used in interior/exterior parts of a vehicle has been applied using raw materials such as a soft type resin and a surface texture conditioner. The texture forming paint may be applied to a material for parts of a vehicle to implement a predetermined texture.

The texture paint including polyester resin, silicon, urethane, or acrylic bead uses polyester alone and therefore has high soft feel to maximize a texture which may be felt by a consumer, but has reduced weather resistance due to characteristics of polyester and therefore may cause paint film badness such as discoloration and cracks when being exposed to sunlight for a long period of time. Further, the paint including polyester and polycarbonatediol has more excellent physical properties compared to a composition including polyester alone, but has a limitation of implementing a texture. At present, the paint including polycarbonatediol which is most frequently used in the texture paint may implement high elasticity, but may have a reduced soft texture compared to polyester.

All of the above-mentioned paints may implement a two-dimensional texture, but consumers may never feel the texture due to their high sensitive quality level. In the case of the two-dimensional texture which is currently implemented as compared to the high sensitive quality, the characteristics of the texture paint do not appeal the soft feel in the state in which only the elasticity is higher as compared with the time when the texture paint is introduced.

### SUMMARY

An embodiment of the present invention relates to a composition for painting and varnishing parts of a vehicle capable of implementing a three-dimensional texture (for example, napping pattern or suede feeling) so as to reach a high sensitive quality of consumers.

Another embodiment of the present invention relates to a composition for painting and varnishing parts of a vehicle capable of implementing an advanced touch to the parts of a vehicle and a texture similar to that of leather and improving marketability of parts of a vehicle.

In one embodiment, a composition for painting and varnishing parts of a vehicle, includes: 20 to 50 wt % of thermosetting resin; 1 to 10 wt % of thermal expandable microsphere; 3 to 20 wt % of pigment; 5 to 20 wt % of hardener; 1 to 20 wt % of additives; and a residual solvent.

In another embodiment, parts of a vehicle include: a material for parts of a vehicle; and a paint film formed on the material for parts of a vehicle and made of the composition for parts of a vehicle.

### BRIEF DESCRIPTION OF THE DRAWINGS

The above and other aspects, features and other advantages will be more clearly understood from the following detailed description taken in conjunction with the accompanying drawings, in which:

FIG. 1 is a schematic diagram of a process of forming a paint film from a composition for painting and varnishing parts of a vehicle according to an embodiment of the present invention;

FIG. 2 is a detailed diagram of a process of forming a paint film with the passage of heating time of FIG. 1;

FIG. 3 is a cross-sectional view of a microsphere;

FIGS. 4 to 6 are enlarged views of a paint film according to Example 1, Comparative Example 1, and Comparative Example 2, respectively; and

FIGS. 7 and 8 are enlarged views of a paint film according to Comparative Example 3 and Comparative Example 4, respectively.

### DESCRIPTION OF SPECIFIC EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In order to clearly describe the present invention, portions that are not connected with the description will be omitted. Like reference numerals designate like elements throughout the specification. Throughout the present specification, same or like components of the present invention will be described using same or like terms.

Hereinafter, exemplary embodiments of the present invention will be described in more detail.

A composition for painting and varnishing parts of a vehicle according to an embodiment of the present invention is coated on a material for parts of a vehicle to implement a texture having a three-dimensional shape as compared to a paint implementing a two-dimensional texture according to the related art. The “parts of a vehicle” is not particularly limited, but may include interior/exterior parts of a vehicle such as a center garnish, a vehicle sheet, a side sill moulding, a side garnish, and a side protector and the “parts of vehicle” may include a thermoplastic polyolefin (TPO) material, and the like, including vehicle interior plastic, leather, polypropylene, polyethylene, and the like, but is not limited thereto. The composition may include a resin, a pigment, a microsphere, a hardener, and a solvent and may further include additives.

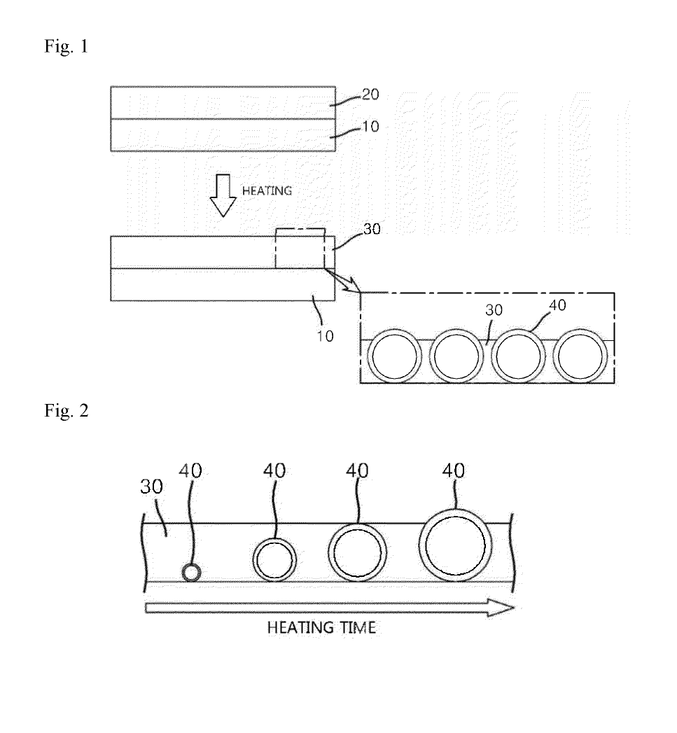

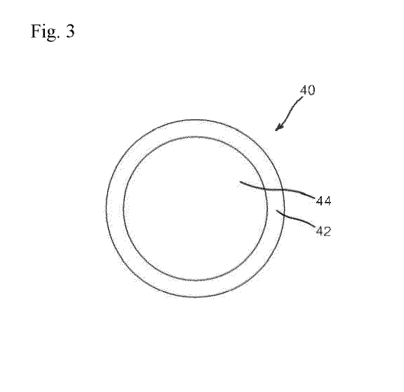

A paint film made of the composition includes a thermally expandable microsphere and when a coating layer made of the painting composition is heated, the microsphere is expanded by heat to form napping-shaped protrusions on a surface of the paint film, thereby implementing the coating layer having a three-dimensional texture. FIG. 1 is a schematic diagram of a process of forming a paint film from a composition for painting and varnishing parts of a vehicle according to an embodiment of the present invention. Referring to FIG. 1, a paint film 30 may be formed on a material 10 for parts of a vehicle by coating and heating a painting composition 20 on the material 10 for parts of a vehicle and when a cross section of the paint film 30 is enlarged, a portion of the expanded microsphere 40 is exposed on an upper surface of the paint film 30 to implement the three-dimensional texture on the paint film 30. The microsphere has thermal expansion with the passage of heating time and thus an average particle thereof is increased and FIG. 2 is a detailed diagram of a process of forming a paint film with the passage of heating time of FIG. 1. Referring to FIG. 2, in an initial step of heating, the average diameter of the microsphere 40 is smaller than a thickness of the paint film 30 and thus the microsphere is included in the paint film, but the microsphere is thermally expanded with the passage of heating time and thus a portion of the microsphere is exposed to the outside. Preferably, the average diameter of the microsphere expanded to implement the three-dimensional texture may be larger than the thickness of the paint film, in which the average diameter of the expanded microsphere may be 60 to 150 μm, for example, 60, 65, 70, 75, 80, 85, 90, 95, 100, 105, 110, 115, 120, 130, 135, 140, 145, and 150 μm and the thickness of the paint film may be 50 to 70 μm, for example, 50, 51, 52, 53, 54, 55, 56, 57, 58, 59, 60, 61, 62, 63, 64, 65, 66, 67, 68, 69, and 70 μm. In the above range, the microsphere may be used in the material for parts of a vehicle and may implement the three-dimensional texture.

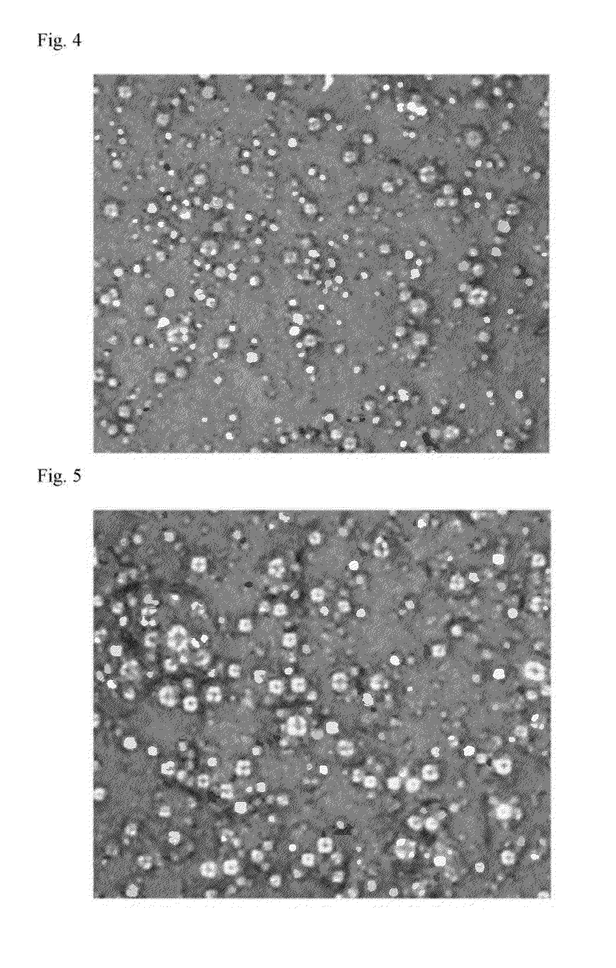

The cross section of the expandable microsphere is illustrated in FIG. 3. Referring to FIG. 3, the microsphere 40 may include an outside 40 made of thermoplastic resin and a foaming agent which is included in the outside 42 and is vaporized by heating. The microsphere is thermally expanded in a predetermined temperature range to form the napping-shaped protrusions on the paint film, thereby implementing the three-dimensional shape. The thermal expansion temperature of the microsphere may be 70 to 300° C., for example, 70, 80, 90, 100, 110, 120, 130, 140, 150, 160, 170, 180, 190, 200, 210, 220, 230, 240, 250, 260, 270, 280, 290, and 300° C.

The outside of the microsphere has affinity with the resin, the pigment, and various additives included in the painting composition and may be made of resin which prevents the microsphere from cracking even by the thermal expansion of the defoaming agent. In a detailed example, the outside may be made of a polymerizable monomer having at least one polymerizable double bond and a polymerization initiator, in which the polymerizable monomer may include at least one of (meta) acrylic monomer and vinyl chloride monomer and the polymerization initiator may include peroxide, azo compound, and the like as the general initiator. The outside further includes a cross-linking agent to suppress a reduction in a persistency rate of the included foaming agent at the time of thermal expansion, thereby effectively thermally expanding the microsphere, in which the cross linking agent may include aromatic divinyl compounds such as divinylbezene and di(meta)acrylate compounds such as 1,4-butanediol di(meta)acrylate and one cross linking agent or at least two cross linking agents may be included.

The foaming agent in the microsphere is a material which is vaporized by heating and has a boiling point which is equal to or less than a softening point of the resin and thus is vaporized by the thermal expansion of the microsphere, thereby generating a vapor pressure sufficient to expand the microsphere and provide a high expansion magnification. The boiling point of the foaming agent needs to be lower than the softening point of the thermoplastic resin, for example, may be 20 to 40° C. In the above range, the protrusion shape may be implemented at the time of hardening the composition.

The foaming agent may include a liquid component or a gas component of hydrocarbon having a low boiling point or hydrocarbon having a high boiling point. The hydrocarbon having a low boiling point has a boiling point which generally ranges from −20° C. or more to less than 170° C., for example, is straight-chain, branched, or aliphatic hydrocarbon having C4 to C9 and an example of the hydrocarbon may include isobutane, cyclobutane, cyclopentane, isopentane, cyclopentane, hexane, isohexane, cyclohexane, heptane, iso-heptane, 3-ethyl-pentane, 3-methyl hexane, and the like but is not limited thereto. The hydrocarbon having a high boiling point has a boiling point which generally ranges from 170° C. or more to 360° C. or less, for example, may be straight-chain, branched, or aliphatic hydrocarbon having C10 to C20.

The average diameter of the microsphere is 50 μm or less, for example, 6 to 10 μm, for example, 6, 7, 8, 9, and 10 μm, but is thermally expanded when being heated up to the predetermined temperature. The thermal expansion initiation temperature of the microsphere is not particularly limited, but may be 70° C., for example, 70 to 100° C., for example, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100° C., and when the microsphere is continuously heated, the microsphere may be thermally expanded and the maximum thermal expansion temperature may be 270° C., for example, 270 to 285° C., for example, 270, 271, 272, 273, 274, 275, 276, 277, 278, 279, 280, 281, 282, 283, 284, and 285° C. When a ratio of an average particle when the microsphere is maximally thermally expanded to a first average particle before the microsphere is heated is set to be a maximum expansion magnification, the maximum expansion magnification of the microsphere may be equal to or more than 50, for example, may be 50 to 100. In the above range, when the microsphere is included in the paint film, the phenomenon that the microsphere is separated from the paint film may be prevented.

The three-dimensional napping-shaped protrusions may be formed on the paint film due to the thermal expansion of the microsphere and a coefficient of thermal expansion may be 1 to 20 μm/° C. In the above range, the microsphere is thermally expanded in a predetermined temperature range, thereby implementing the three-dimensional texture.

The microsphere may be included at 1 to 10 wt %, preferably, 2 to 5 wt %, for example, 1, 2, 3, 4, 5, 6, 7, 8, 9, and 10 wt % in the painting composition. When the microsphere is less than 1 wt %, the reduction in texture may occur due to the deficiency of the protrusions of the coating layer and when the microsphere exceeds 10 wt %, the microsphere is separated from the coating layer due to the protrusions excessively formed on the coating layer, such that the reduction in physical properties and texture may appear.

The resin forms a matrix of the paint film and any component which has an adhesion to the material for parts of a vehicle, has excellent physical properties even after the painting composition is hardened, is not melted even though the outside temperature rises during the thermal expansion process of the microsphere, and prevents the paint film from cracking when the microsphere reaches normal temperature even after the thermal expansion of the microsphere is completed may be used without limit. In a detailed example, the coefficient of thermal expansion of the resin needs to be lower than that of the microsphere. Therefore, the microsphere is thermally expanded without hindering the thermal expansion of the microsphere, thereby implementing the three-dimensional texture. In a detailed example, the resin is a resin having high elasticity and has a specific gravity higher than that of the microsphere and therefore may help move the microsphere to the top surface of the paint film when the microsphere is included in the paint film.

For example, the resin is a resin having at least one hydroxyl group (—OH) as a thermoplastic or thermosetting resin and may include at least one of polyester, polycarbonate, polycarbonatediol, acryl, melamine, and vinyl chloride resin. The resin provides hardening reaction with a hardener, for example, an isocyanate containing hardener, thereby forming the paint film.

The hardening temperature of the resin may be 90 to 200° C. and in the above range, the microsphere may be thermally expanded simultaneously with hardening the composition.

The resin may be included at 20 to 50 wt %, preferably, 30 to 40 wt %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 wt % in the painting composition. When the resin is less than 20 wt %, the thickness of the paint film is reduced under the current painting environment in which the painting frequency is limited due to the reduction in a resin solid content in the composition, such that the abrasion resistance among mechanical physical properties which are affected by the thickness of the painting film is reduced and the permeation of chemical materials (for example, sun cream) from the surface of the coating layer to the material layer for parts of a vehicle among chemical physical properties is facilitated, such that the peeling of the coating layer from the material layer occurs, thereby degrading the quality of the painting working. When the resin exceeds 50 wt %, the content of the resin is higher than that of the pigment, the additives, and the solvent which are other components in the composition, such that a cross linking speed (hardening reaction acceleration speed), a paint dry speed, a texture forming quantity, and hiding power which may not be supplemented by the resin may be reduced, and when the content of the resin is excessive, an injection amount of a reaction promoter which may control the reaction speed cannot but relatively reduced and thus the reaction speed may be reduced, the hardening temperature and the hardening time need to be increased to supplement the reaction speed and thus the productivity may be reduced, and the content of the solvent which may control the dry speed of the surface of the paint film is relatively reduced and thus it is impossible to control the dry speed in response to the change in the painting working condition, such that the surface badness of the paint film such as orange peel and the occurrence of cratering occurs, thereby reducing the quality of painting working, the content of the microsphere, a matting agent, and waxes is relatively reduced and the surface napping distribution is reduced.

In particular, even though 1 to 10 wt % of microsphere is included, in the case in which the resin exceeding 50 wt % is included, the expansion trace of the microsphere on the paint film may be confirmed with the naked eye, but the microsphere which is insufficient to feel the texture of the surface leather due to the increase in the resin content forming the paint film is distributed and due to the non-injection of the additives depending on the increase in the resin content, the phenomenon that the surface slip property is reduced, the gloss is increased, and the hardening dry is insignificant occurs.

The pigment is to implement a color of the coating layer and may include an organic pigment, an inorganic pigment, or a mixture thereof. The pigment may include a pigment having high brightness like white or a pigment having low brightness like black depending on a color and when the pigment may include a pigment having low brightness, the hiding power may be increased and the pigment having high brightness may also be used to implement a color having high chroma.

In a detailed example, the pigment may include oil absorption of 10.5 to 15.5 ml/100 g, for example, may include a pigment which includes oil absorption of 10.5, 11, 11.5, 12, 12.5, 13, 13.5, 14, 14.5, 15, 15.5 ml/100 g. In the above range, even though an excessive amount of pigment is injected, a solvent and resin are absorbed and thus the badness such as the crack of the surface of the paint film and the sudden reduction in gloss, and the like which occur in the dry process at the time of forming the paint film may not occur and the paint may be produced without difficulty even at the viscosity which may not perform the painting.

The pigment is not thermally decomposed at the hardening temperature of resin and the thermal decomposition temperature may be 600 to 900° C. In the above range, the pigment is not thermally decomposed and thus the unique color of the paint film may be implemented.

The pigment may be included at 3 to 20 wt %, preferably, 3 to 15 wt %, for example, 3, 4, 5, 6, 7, 8, 9, 10, 11, 12, 13, 14, 15, 16, 17, 18, 19, 20, 21, 22, 23, 24, 25, 26, 27, 28, 29, and 30 wt % in the painting composition. When the pigment is less than 3 wt %, the workability of the painting composition is poor and thus the uniformity of the coating layer may be poor and the hiding power may be reduced, and the excessive paint film is formed due to the hiding badness and thus the production yield may be reduced at the time of painting, and the flow of the paint film and the interruption of the paint film may occur due to the excessive formation of the paint film. When the pigment exceeds 20%, the pigment is agglomerated and thus the appearance of the coating layer is poor, such that the pigment may have a difficulty in storage.

In particular, the composition in which the resin exceeding 50% and the pigment less than 3% are included may cause the phenomenon that the gloss is increased, the hiding power is reduced, and the coating layer is not dried. Further, the painting composition in which the resin less than 20 wt % and the pigment exceeding 15 wt % are included is not dispersed well while the composition is prepared, such that the painting working may not be performed.

As the hardener which is a component to harden the resin, an isocyanate-based hardener may be used. In this case, as the isocyanate-based harder, a trimer type of isocyanate-based hardener which is generally used in the paint for a vehicle may be used. The hardener may be added later at 5 to 20 wt %, for example, 5, 6, 7, 8, 9, 10, 11, 12, 13, 14, 15, 16, 17, 18, 19, and 20 wt % in the composition for painting and varnishing parts of a vehicle. In the above range, the hardener may sufficiently harden the painting composition and some of the hardener remains to prevent the physical properties of the paint film from deteriorating.

The solvent help the composition for painting and varnishing parts of a vehicle keep an appropriate viscosity to increase paintability and may include an oil solvent or an aqueous solvent. As the oil solvent which is a solvent without miscibility with water, for example, a hydrocarbon-based solvent having C1 to C20 may be used and as the aqueous solvent, a mixture of a solvent such as alcohol with miscibility with water may be used.

The solvent may be included at a residual amount other than the resin which is a solid content, the microsphere, the pigment, and the additives from the composition for painting and varnishing parts of a vehicle, for example, 20 to 30 wt %. In the above range, the composition is keep at an appropriate viscosity and may increase the coating easiness and the paintability of the composition. The composition for painting and varnishing parts of a part may have a viscosity of 70 to 100 ku at 25° C.

The composition for painting and varnishing parts of a vehicle may further include additives. The additives are to provide additional physical properties to the coating layer, for example, may include at least one of a UV absorber or a photostabilizer (hindered amine light stabilizer (HALS)) for preventing the aging of the coating layer from sunlight, a leveling agent of a silicon-based or acrylic material, a matting agent of SiO2 component for controlling the gloss of the coating layer, waxes for preventing the sedimentation of the pigment and the matting agent, and a dispersant for facilitating the dispersion of the pigment.

The additives may be included at 1 to 20 wt % in the composition for painting and varnishing parts of a vehicle. In the above, the effect of the additives may be implemented and the painting composition and the painting state may be kept optimally. In a detailed example, the UV absorber in the composition may be included at 1 to 10 wt %, the HALS may be included at 1 to 5 wt %, the leveling agent may be included at 5 to 10 wt %, the matting agent may be included at 1 to 10 wt %, the waxes may be included at 1 to 10 wt %, and the dispersant may be included at 1 to 5 wt %.

The composition for painting and varnishing parts of a vehicle may be prepared by a typical method. For example, the composition for painting and varnishing parts of a vehicle may be prepared by mixing simultaneously or sequentially adding the resin, the pigment, the microsphere, and the additives with the solvent.

According to another embodiment of the present invention, the parts of a vehicle may include a paint film layer which is made of the composition for painting and varnishing parts of a vehicle. In a detailed example, the parts of a vehicle may include a material for parts of a vehicle; and the paint film layer which is formed on the material for parts of a vehicle.

The paint film layer may be manufactured by coating and heating the composition for painting and varnishing parts of a vehicle on the material for parts of a vehicle. A method for coating the painting composition is not particularly limited and therefore gravure coating, spin coating, and the like may be used.

A coating thickness of the composition for painting and varnishing parts of a vehicle ranges from 50 to 70 μm and in the above range, the protrusions may be exposed outside of the paint film due to the thermal expansion of the microsphere, such that the three-dimensional texture may be implemented. After the composition for painting and varnishing parts of a vehicle is coated, the heating temperature may be controlled depending on the hardening temperature of the resin, for example, 70 to 200° C. and in the above range, the paint film may be formed and the thermal expansion of the microsphere is good, such that the three-dimensional texture may be implemented. When the heating temperature is less than 70° C. depending on the structure of the microsphere, the thermal expansion of the microsphere is not performed properly and thus the three-dimensional texture may be reduced and when the heating temperature exceeds 300° C., the thermal expansion of the microsphere is excessive and thus the microsphere may be separated from the paint film or the microsphere may burst. Preferably, the heating temperature may be 80 to 275° C., more preferably, 80 to 105° C., most preferably, 80 to 104.9° C. The heating time may be changed depending on the hardening time of the resin and the coating thickness, for example, may be 40 minutes to 1 hour and in the above range, the paint film may be formed and the thermal expansion of the microsphere is performed well, such that the three-dimensional texture may be implemented.

Prior to coating the composition for painting and varnishing parts of a vehicle, the method for coating the painting composition further includes cleaning or plasma-treating the surface of the material for parts of a vehicle, such that foreign materials of the material for parts of a vehicle may be removed or the uniformity of the coating layer may be secured. The cleaning may include treating the material for parts of a vehicle with a typical cleaning solvent and the plasma treating may include plasma-treating the material for parts of a vehicle with argon, and the like.

The thickness of the paint film layer ranges from 50 to 70 μm and in the above range, the paint film may be used in the material for parts of a vehicle and the three-dimensional texture may be implemented due to the thermal expansion of the microsphere.

The material for parts of a vehicle including the paint film layer may have the excellent adhesion, chemical resistance, sun cream resistance, PVC plasticizer property, abrasion resistance, and scratch resistance and implement the satisfactory reliability in light resistance, heat resistance, moisture resistance, and heat-resistant cycle property. In addition, excellent reliability in the performance test may be shown and no reflection by light is present.

Hereinafter, a configuration and an action of the embodiment of the present invention will be described with reference to preferred Examples of the present invention. However, this is proposed as a preferred example of the present invention and therefore the present invention need not be construed as being limited thereto.

In the following Examples and Comparative Examples, the detailed specifications of the used component are as follows.

As the resin, a polycarbonatediol resin (PCDL, Asahikasai) was used, as the microsphere, a microsphere grade (Matsumoto) was used, as the pigment, a carbon black pigment (Monarch-, Cabot) was used, as the hardener, Coronate (Nippon polyurethane) was used, as the UV absorber in the additives, Tinuvin (Basf) was used, as the leveling agent, Afcona (Afcona) was used, as the matting agent, Acematt (Degussa) was used as the wax, Flownon (Gongyoung Inc.), and as the solvent, butyl acetate was used.

### EXAMPLE 1

The resin, the microsphere, the pigment, the additives, and the solvent ware mixed in contents disclosed in the following Table 1 (unit: weight part) to prepare the composition for painting and varnishing parts of a vehicle. The prepared composition was coated on the center garnish which is a plastic part for an interior of a vehicle which is injected and painted with a PC/ABS material and dried at 95° C. for 40 minutes to form the paint film layer.

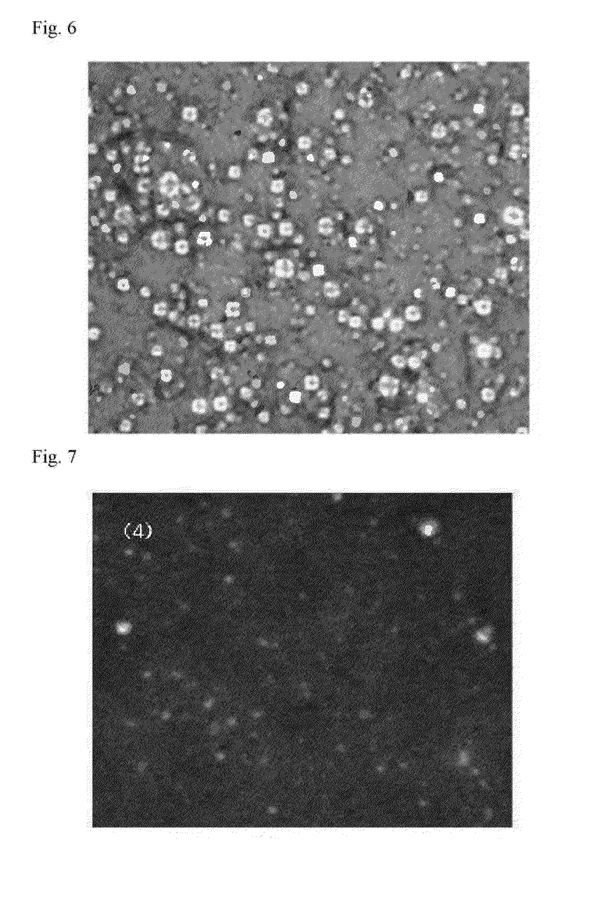

It was confirmed from FIG. 4 that the surface texture is completed while the napping is completed and thus the surface gloss disappears due to the drying of the paint film and some of the expanded portion of the microsphere is exposed on the surface of the paint film due to the expansion of the microsphere. Further, the plastic part was mounted in a cockpit module and the heat-resistant cycle test of the module was performed. A test method measured and evaluated a spaced degree and a step between the center garnish and the plastic part therearound after and before the heat-resistant cycle. It was confirmed that after the heat-resistant cycle of the painted product, the difference in appearance satisfies a standard. The configuration of the heat-resistant cycle is made by setting one which is (1) kept at an atmosphere temperature of 85° C. for 4 hours, (2) kept at a normal temperature 23° C. for 1 hour, (3) kept at −40° C. for 1 hour, (5) kept at a relative humidity of 90% at 50° C. for 7 hours, and (6) then kept at a normal temperature of 23° C. for 1 hour as 1 cycle and the configuration from (1) to (6) is repeatedly performed 3 times in total. Further, at the time of being kept at 85° C. for 4 hours which is the section (1), the surface temperature of the paint film layer of the part by irradiating an IR lamp on the surface is 120° C.

### EXAMPLE 2

The paint film was formed by the same method as Embodiment 1 except that the contents of each component in Embodiment 1 are changed as the following Table 1.

### COMPARATIVE EXAMPLE 1

The paint film layer was formed by the same method as Embodiment 1 except that the paint film layer is formed by being coated on the plastic part for an interior of a vehicle and being dried at 105° C. for 40 minutes. It was confirmed from FIG. 5 that the napping is formed in a giant and excessive circular shape as compared with the thickness of the paint film in the step of primarily, excessively forming and expanding the napping and thus the texture is improved or the physical properties of the paint film layer are hindered while the microsphere is excessively exposed due to the expansion of the microsphere.

### COMPARATIVE EXAMPLE 2

The paint film layer was formed by the same method as Embodiment 1 except that the paint film layer is formed by being coated on the plastic part for an interior of a vehicle and being dried at 115° C. for 40 minutes. It was confirmed from FIG. 6 that the napping is excessively distributed in the maximum expansion step of the microsphere and the damage of the paint film occurs while the microsphere is destroyed due to the continuous high heat in the excessive expansion step.

### COMPARATIVE EXAMPLES 3 TO 7

Comparative Example 3 is the case in which the content of the microsphere is less than 1 wt %, Comparative Example 4 is the case in which the resin is included at 50 wt % or more, Comparative Example 5 is the case in which the resin exceeds 50 wt % and the pigment is less than 3 wt %, Comparative Example 6 is the case in which the resin is less than 20 wt %, and Comparative Example 7 is the case in which the content of the microsphere exceeds 10 wt %.

TABLE 1

| | | | | | | | | Dry | | |
|---|---|---|---|---|---|---|---|---|---|---|
| | | | | | | | | temperature | Dry time | |
| | Resin | Pigment | Microsphere | Hardener | Additives | Solvent | Sum | ° C. | (minute) | Result |
| Example 1 | 40 | 5 | 2 | 15 | 8 | 30 | 100 | 95 | 40 | Good in texture |
| | | | | | | | | | | and physical |
| | | | | | | | | | | properties |
| Example 2 | 35 | 5 | 1 | 15 | 8 | 36 | 100 | 95 | 40 | Good in texture |
| | | | | | | | | | | and physical |
| | | | | | | | | | | properties |
| Comparative | 40 | 5 | 5 | 15 | 8 | 27 | 100 | 105 | 40 | Separation of |
| Example 1 | | | | | | | | | | microsphere |
| Comparative | 35 | 5 | 3 | 15 | 8 | 34 | 100 | 115 | 40 | Separation of |
| Example 2 | | | | | | | | | | microsphere |
| Comparative | 40 | 5 | 0.5 | 15 | 8 | 31.5 | 100 | 95 | 40 | Reduction in |
| Example 3 | | | | | | | | | | gloss and |
| | | | | | | | | | | increase in |
| | | | | | | | | | | gloss |
| Comparative | 55 | 5 | 2 | 15 | 8 | 15 | 100 | 95 | 40 | Reduction in |
| Example 4 | | | | | | | | | | gloss and |
| | | | | | | | | | | increase in |
| | | | | | | | | | | gloss |
| Comparative | 55 | 1.0 | 2.0 | 15 | 8 | 19 | 100 | 95 | 40 | Increase in |
| Example 5 | | | | | | | | | | gloss and |
| | | | | | | | | | | vulnerable to |
| | | | | | | | | | | hiding power |
| Comparative | 15 | 5 | 5 | 15 | 8 | 52 | 100 | 95 | 40 | Disabling of |
| Example 6 | | | | | | | | | | painting |
| | | | | | | | | | | working due to |
| | | | | | | | | | | increase in |
| | | | | | | | | | | paint viscosity |
| Comparative | 40 | 5 | 10 | 15 | 8 | 22 | 100 | 95 | 40 | Separation of |
| Example 7 | | | | | | | | | | microsphere |

It was confirmed from the above Table 1 and FIG. 4 that the surface texture is completed while the surface gloss of the paint film made of the composition of the present invention disappears due to the drying of the paint film and some of the expanded portion of the microsphere is exposed on the surface of the paint film due to the expansion of the microsphere.

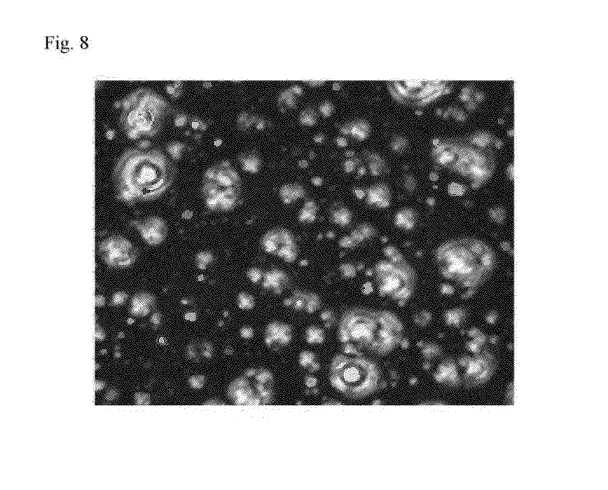

On the other hand, Comparative Example 3 in which the microsphere is less than 1 wt % was confirmed that the expansion trace is partially present on the paint film as illustrated in FIG. 7 but the distribution enough to feel the texture is not shown. Further, Comparative Example 4 in which the resin exceeds 50 wt % may confirm that the microsphere is circularly expanded as illustrated in FIG. 8, but was confirmed that the microsphere insufficient to feel the surface leather texture due to the increase in the resin content is distributed, the surface slip property is reduced due to the non-injection of the additives in response to the increase in the resin, the gloss is increased, and the hardening drying is insignificant.

Comparative Example 5 in which the resin exceeds 50 wt % and the pigment is less than 3 wt % was confirmed that the gloss is increased and the hiding power is insufficient and Comparative Example 6 in which the resin is less than 20 wt % and the pigment exceeds 15 wt % was confirmed that the dispersion process is not performed well during the process of preparing the composition and thus the painting working is not performed. Further, Comparative Example 7 in which the content of the microsphere exceeds 10 wt % was confirmed that the protrusions are separated from the paint film due to the protrusions excessively formed on the paint film and therefore the physical properties of the paint film and the reduction in texture appear.

According to the composition for painting and varnishing parts of a vehicle in accordance with the embodiments of the present invention, it is possible to implement the three-dimensional texture (for example, napping pattern or suede feeling) so as to reach a high sensitive quality of consumers, implement the advanced touch to the parts of a vehicle and the texture similar to that of leather and improving the marketability of parts of a vehicle. Further, the paint film made of the composition for painting and varnishing parts of a vehicle in accordance with the embodiments of the present invention may implement the excellent adhesion, chemical resistance, sun cream resistance, PVC plasticizer property, abrasion resistance, and scratch resistance and implement the satisfactory reliability in light resistance, heat resistance, moisture resistance, and heat-resistant cycle property. In addition, excellent reliability in the performance test may be shown and no reflection by light is present.

The simple modifications and changes of the present invention may be easily practiced by those skilled in the art and therefore it is to be construed that these modifications or changes are included in the scope of the present invention.

What is claimed is:

1. A composition for painting and varnishing parts of a vehicle, comprising:
20 to 50 wt % of thermoplastic resin or thermosetting resin;
1 to 10 wt % of thermal expandable microsphere;
3 to 20 wt % of pigment;
5 to 20 wt % of hardener;
1 to 20 wt % of additives; and
a residual solvent.

2. The composition of claim 1, wherein a coefficient of thermal expansion of the thermosetting resin is lower than that of the thermal expandable microsphere.

3. The composition of claim 1, wherein the resin includes at least one of polyester, polycarbonate, polycarbonate diol, acryl, melamine, and vinyl chloride resin.

4. The composition of claim 1, wherein the thermal expandable microsphere includes an outside made of thermoplastic resin and a foaming agent which is included in the outside, is vaporized by heating and is hydrocarbon having a low boiling point, hydrocarbon having a high boiling point, or a mixture thereof.

5. The composition of claim 1, wherein the thermal expansion initiation temperature of the thermal expandable microsphere is 70 to 275° C.

6. The composition of claim 4, wherein the outside is made of polymerizable monomer having at least one polymerizable double bond and a polymerizable initiator.

7. The composition of claim 6, wherein the outside further includes a cross linking agent.

8. The composition of claim 1, wherein the pigment has oil absorption of 10.5 to 15.5 ml/100 g.

9. Parts of a vehicle, comprising:
a material for parts of a vehicle; and
a paint film formed on the material for parts of a vehicle and made of the composition for parts of a vehicle of any one of claims 1 to 8.

10. The parts of a vehicle of claim 9, wherein an average diameter of the microsphere after the thermal expandable microsphere is thermally expanded is larger than a thickness of the paint film.
